(19) United States
(12) Patent Application Publication
(10) Pub. No.: US 2011/0266093 A1
(43) Pub. Date: Nov. 3, 2011

(54) MOWER LIFTING DEVICE

(76) Inventor: STAN KAMINSKY, Newton, NJ (US)

(21) Appl. No.: 12/772,321

(22) Filed: May 3, 2010

(51) Int. Cl. B66F 9/06

(52) U.S. Cl. 187/222

(57) ABSTRACT

A lifting device comprising a lift, a platform, a support bar which secures the platform to the lift, a golf cart, and an attachment means which connects the lift to the golf cart wherein when the mower lifting device is coupled with the golf cart the lift enables the platform to raise from a lower position to an upper position, and the golf cart easily operates while the platform is in the upper position. The mower-lifting device enables the golf cart to conveniently transport a greens mower from a plurality of greens in a golf course. This allows for faster maintenance of the greens, and less damage to the lawns and to the grounds keeper's vehicles.

### BACKGROUND OF THE INVENTION

1. Field of Invention

The present invention relates to a lifting device for golf carts, which may transport equipment such as a large greens mower.

2. Description of Related Art

A favorite pastime for many individuals is golfing. With its great popularity, most cities have at least one golf course where its residents can enjoy an afternoon on the greens. The golf course owners understand that with the golfers comes the responsibility of daily maintenance to keep the course beautiful and up to par for the players.

Presently, the lawn mowers used to cut the course greens are specifically designed to keep the grass short without killing the soil beneath. Grounds keepers typically use push mowers because the large riding mowers may damage the delicate grass on the greens. With most golf courses consisting of at least nine holes, the grounds keeper and their mowers are continuously mowing or transporting the mower from hole to hole. On greens located closer to the clubhouse, the grounds keeper may simply walk the mower onto the green. For the more distant holes keepers may load the mower onto a truck or tractor to transport the mower to the green. Walking the mowers to the greens can be tiring and time consuming. Transporting on a truck can be cumbersome having to raise and lower the mower while loading and unloading. The problem with the trucks and tractors is that there are no roads that connect the holes of the course, only the narrow golf cart tracks connect one hole to the next. The trucks and tractors may be damaged by repeatedly loading the mowers and the truck and tractors may damage the lawns along the tracts because the size of their wheels.

It would be desirable in the art to have an efficient and convenient way to transport the greens mower without having to place the mower on a truck which can damage both trucks and the fairways or having to walk the mower which is time consuming and tiring.

### SUMMARY OF THE INVENTION

The primary purpose of the present invention is to provide a mower-lifting device for golf carts which may transport a large greens mower. The mower may be lifted by the mower-lifting device onto the front end of a golf cart by using an actuator to lift a platform under the mower. The device may allow easier transport of the greens mower without causing damage to the golf course greens or the golf cart.

Another object of the present invention is to allow the mower to rest at an angle against the golf cart while lifted on the platform for secure transportation.

Another object of the present invention is to provide a means to attach and then easily detach the mower-lifting device from the front of the cart for added ease and convenience.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

FIG. 1. is a perspective view of the present invention.

### DETAILED DESCRIPTION OF THE DRAWINGS

The present invention relates to a mower-lifting device which provides a means to transport a greens mower on a golf cart. The mower-lifting device may utilize a platform to lift the greens mower and transport the mower from green to green. The mower lifting device may allow golf course grounds keepers to more easily maintain the greens by allowing the mowers to be transported instead of walked, and convenient loading and unloading on the platform.

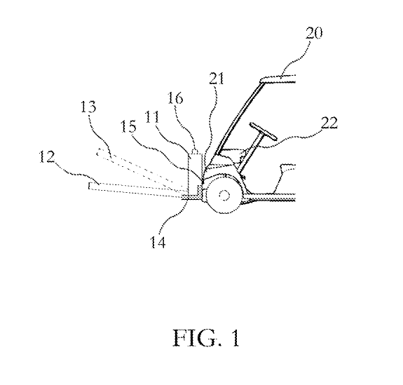

Turning now descriptively to the drawing, referring to FIG. 1, a perspective view of a mower-lifting device (10) is shown, which may comprise a lift (11) and a platform (12). The lift (11) may house a motor to raise and lower the platform (12). The motor may be a 12-volt actuator motor or another motor type known and used in the art. The lift (11) may move the platform (12) from a lower position, which may rest on the ground, to an upper position. When the platform (12) is in the lower position a greens mower (not shown) may be rolled onto the platform (12). The lift (11) may then raise the platform (12) together with the greens mower to the upper position. The upper position may come to rest about 6-8 inches above the ground level. While in the upper position, the platform may rest at an angled position (13) ranging from about 20-30 degrees. The angled position (13) of the platform helps to secure the greens mower against the lift (11) for safe and secure transportation.

The platform (12) may be attached to the lift (11) using a support bar (14). The support bar (14) may be an angle iron or other readily known fastening means. The support bar (14) may give the mower lifting device (10) greater support when the lift (11) moves the platform (12) from the lower to the raised upper position. The platform (12) may be comprised of a steel plate or another strong and sturdy material known and used in the art. The mower-lifting device (10) may lift a greens mower not exceeding 200 pounds.

The mower-lifting device (10) may be attached to a cushioned suspension (21) of a golf cart (20) by an attachment means (15). In one exemplary embodiment, the attachment means (15) may attach to the golf cart (20) in as a snowplow attaches to a truck. The attachment means (15) may give support and stability to the lift (11) when the lift (11) moves the platform (12) from the lower position to the upper position. By attaching the mower-lifting device (10) to the golf cart (20), the greens mower may easily be transported from green to green for fast and efficient golf course maintenance. When the mower-lifting device (10) is not attached, it may be stored in a garage or storage shed. The mower-lifting device (10) is significantly smaller than a truck or tractor thus saving extra storage room when not in use.

A control unit (16) may be attached the lift (11) to activate the motor. The control unit (16) may have a button or a crank to operate the lift (11). The control unit (16) may also attach to the golf cart on a dash board (22) so that a person may operate the mower-lifting device (10) while seated in the golf cart (20).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

What is claimed is:

1. A lifting device for lifting and transporting equipment comprising:
a lift;
a platform, where said platform extends from the lift;
a support bar, where said support bar secures the platform to the lift; and
an attachment means, where the attachment means attaches the lift to a vehicle wherein when the lifting device is coupled with the vehicle, and where the lift positions the platform in one of a lower position and an upper position.

2. The lifting device according to claim 1, wherein the lift includes a motor.

3. The lifting device according to claim 2, wherein the motor includes a 12-volt actuator.

4. The lifting device according to claim 1, wherein the lift has a control unit, where said control unit enables the operation of the lift.

5. The lifting device according to claim 1, wherein while the platform in the upper position, the platform rests at an angle.

6. The lifting device according to claim 5, wherein the angle ranges from about 20 degrees to about 30 degrees.

7. The lifting device according to claim 1, wherein the platform supports a greens mower.

8. The lifting device according to claim 1, where said vehicle includes a golf cart.
